(19) United States
(12) Patent Application Publication
(10) Pub. No.: US 2024/0384935 A1
(43) Pub. Date: Nov. 21, 2024

(54) MANUFACTURED SPRAY COOLING WATER FOR GRAPHITE ELECTRODES

(71) Applicant: CHEMTREAT, INC., Glen Allen, VA (US)

(72) Inventors: James R. LAWSON, Louisville, TN (US); Alan J. Feller, Macy, IN (US); Robert Jeffers, Glen Allen, VA (US); Jeremy Leitze, Avon, IN (US)

(73) Assignee: CHEMTREAT, INC., Glen Allen, VA (US)

(21) Appl. No.: 18/663,732

(22) Filed: May 14, 2024

Related U.S. Application Data
(60) Provisional application No. 63/467,674, filed on May 19, 2023.

(51) Int. Cl. F27D 11/08; F27D 9/00

(52) U.S. Cl. CPC F27D 11/08; F27D 2009/0016

(57) ABSTRACT

Systems and methods for cooling a graphite furnace electrode with manufactured spray cooling water for high-temperature furnace electrodes. The manufactured spray cooling water can be engineered to have desired properties and/or components that improve sidewall oxidation losses. The manufactured spray cooling water can be produced by modifying a water source that is used to cool the electrodes to provide a more pure water and optionally adding an additive to the more purified water.

### CROSS-REFERENCE TO RELATED APPLICATIONS

This application claims the earlier filing date benefit of U.S. Provisional Application No. 63/467,674, fled on May 19, 2023, the entirety of which is incorporated by reference herein.

### TECHNICAL FIELD

This disclosure relates to manufacturing spray cooling water that can be sprayed onto hot graphite electrodes that are used in a furnace, e.g., an electric arc furnace (EAF) or ladle metallurgy furnace (LMF). The manufactured spray water is effective to reduce sidewall oxidation of the graphite electrode as compared with conventionally used spray cooling water.

### BACKGROUND

EAF steel producers use electrical energy to melt raw materials to produce 1 ton to 420 metric tons of steel in vessels. Electrical energy can be delivered to the furnace(s) as alternating current (AC) or direct current (DC). The electrical power delivered to the raw materials can be as high as 200 MWh in the case of the largest EAF vessels. This power supply creates an electrical arc that creates the necessary heat to raise the batch of steel to temperatures as high as 1800° C. and to allow for further refinement and processing in the LMF and subsequent casting and forming operations.

The electrical power is delivered to the steel through graphite electrodes. Graphite is the material of choice for electrodes due to the following characteristics: low coefficient of thermal expansion (CTE), high tensile strength, high specific resistance, electrical resistance that is relatively independent of temperature, and nobility (cathodic to other materials).

Electrodes are consumables utilized in the electrical steel making process and account for a substantial cost for the steel maker. The environment in the electric arc furnace is violent, harsh, and causes consumption of electrodes in a typical range of approximately 1 kg/metric ton of steel produced to 2.5 kg/metric ton. Causes of consumption include: electrical arc at the electrode tip where localized temperature is approximately 3000° C.; electrode breakage due to movement of raw materials; thermal shock and subsequent loss of electrode tip; and oxidation of the electrode surfaces along the column due to the harsh furnace environment. Oxidation of the electrode creates the conical shape of electrodes that are in use and can account for nearly 50% of the electrode consumption.

For decades, steel producers and furnace electrode producers have attempted to reduce the oxidation rate of the graphite and carbon electrodes through many different means. One example is to use electrodes that have surfaces coated with layers formed from graphite, metal, aluminum alloys, and pure aluminum. However, these coatings are only applied once (e.g., only during the manufacturing of the electrodes), and the coatings are susceptible to chemical and physical damage that renders them ineffective. Thus, these types of coatings can have short useful life spans.

Changes in the electrode manufacturing process, in electrode coupling technology, in the recipe for the graphite electrodes, and in operational procedures like foamy slag have substantially reduced electrode consumption since 1985 when electrode consumption was between 5 to 6 kg/metric ton of steel, to 1 to 2.5 kg/metric ton of steel in 2018. While this has been an impressive reduction, market forces have heightened sensitivity to the consumption rate. Even incremental decreases in consumption rate have a substantial impact to the steel maker.

The oxidation of the electrode is a chemical reaction. The rate of oxidation of the electrode increases with increasing temperatures because the reactant molecules have more kinetic energy at higher temperatures. The reaction rate (i.e., oxidation rate) is governed by the Arrhenius equation which in almost all cases shows an exponential increase in the rate of reaction as a function of temperature.

$$k = \frac{- Ea}{{k}_{B} T}$$

Where: k=the rate constant
K_{B}=Boltzmann constant
T=absolute temperature
A=a constant for each chemical reaction
Eₐ=the activation energy
R=the universal gas constant

Therefore, many designs have been developed to cool the bulk of the electrode (i.e., lower the temperature of the electrode), but have been abandoned due to safety concerns. Applying cooling water to the electrode below the molten steel bath creates a very dangerous condition in the case of an electrode break or the failure of the cooling water channel. The release of cooling water below the steel bath creates an explosion due to the rapid expansion as the water changes phase from water to steam with an approximate volumetric expansion of 1,100 times. Electrodes used in commercial steel making are currently composed exclusively of graphite and do not contain cooling water channels.

To further reduce oxidation of the electrode, spray cooling was introduced to the industry and specific designs were developed to cool the electrode using circular spray headers with multiple vertical spray headers located at multiple locations around the circumference of the electrode. Investigation of water application has been employed to enhance safety, optimize cooling, as well as mitigate oxidation of the electrode.

Recently, the Applicant of this application has made significant advances in reducing electrode sidewall oxidation by chemically modifying the spray cooling water with an antioxidant additive. The antioxidant additive can form a protective barrier on the surface of the hot furnace electrode when the water is sprayed onto the electrode during use and the spray water evaporates off of the hot electrode surface.

The EAF and/or LMF spray cooling water source that is used for the electrode cooling water varies depending on the site, and is often chosen to maximize environmental sustainability. Water use intensity and discharge requirements are typical considerations when selecting the source of the furnace spray water. Common spray cooling water sources in steel making plants include city or municipal water, well water, river or lake water, and reuse, recycle, or blow down water from other processes on site, e.g., blow down water from a cooling tower, blow down water from reverse osmosis (RO) treatment, or blow down water from filtration systems. The quality of these water sources is highly variable and the water often has high conductivity and high dissolved solids.

### SUMMARY

It has been discovered in connection with this disclosure that the quality of the water that is used as the spray cooling water can significantly affect the rate of sidewall oxidation of the electrode. In one aspect, the invention described herein can further improve sidewall oxidation of furnace electrodes by controlling the water chemistry of the spray cooling water.

This disclosure provides a method for protecting a furnace electrode from sidewall oxidation. The method can include steps of (i) providing a water source for use in cooling the furnace electrode; (ii) modifying the water source to provide a more purified water that has a lower total dissolved solids (TDS) than the water source; and (iii) spraying a hot surface of the furnace electrode with manufactured spray cooling water, which includes the more purified water, to cool the furnace electrode. The method can also optionally include a step of forming the manufactured spray cooling water by combining the more purified water with at least one additive.

### BRIEF DESCRIPTION OF THE DRAWINGS

FIG. 1 is a graph showing the results of an experiment that measures the oxidation losses of an electrode when treated with various cooling liquids.

FIG. 2 is a graph showing the results of another experiment that measures the oxidation losses of an electrode when treated with various cooling liquids.

FIG. 3 is a graph showing the results of another experiment that measures the oxidation losses of an electrode when treated with various cooling liquids.

FIG. 4 is a schematic diagram illustrating a spray water cooling system according to one embodiment.

FIG. 5 is a schematic diagram illustrating a spray water cooling system according to another embodiment.

FIG. 6 is a schematic diagram illustrating a spray water cooling system according to yet another embodiment.

### DETAILED DESCRIPTION OF EMBODIMENTS

The disclosed methods and systems may be used to provide manufactured spray cooling water for any high-temperature furnace electrodes. As explained below, the manufactured spray cooling water is engineered to have desired properties and/or a desired composition that will improve electrode sidewall oxidation losses. The disclosed manufactured spray water may be used to cool graphite electrodes used in a furnace, such as an electric arc furnace, induction furnace, vacuum induction melting, argon oxygen decarburization, ladle furnace, vacuum oxygen degassing, vacuum degassing, vacuum arc remelting, and electro slag remelting.

As identified above, spray cooling water is conventionally taken from different sources that are available at the facility, and the quality of the water source can be highly variable. Frequently, the spray cooling water source has a high conductivity and may be high in total dissolved solids (“TDS”) and anions such as chlorides, sulfates, and nitrates. For example, industrial waters may have a conductivity that is 5,000 μS/cm or more or 10,000 μS/cm or more, and river or lake water may have a conductivity that is 1,500 μS/cm or more. As explained in detail below, in embodiments of the invention, the spray cooling water can be manufactured to control the water chemistry that is sprayed onto the electrode surface. The spray cooling water can be manufactured by first modifying a water source that is used as the spray cooling water to produce a more purified cooling water. This more purified cooling water can be used as the spray cooling water to directly cool the electrode, or an additive (e.g., minerals) can be optionally added to the purified cooling water and then the additive-containing water can be used as the spray cooling water to directly cool the electrode.

More specifically, to manufacture the spray cooling water, the chosen water source (e.g., site water) can be modified to provide a more pure cooling water which has a lower total TDS, a lower total concentration of ions, and/or a lower concentration of specific target ions. In general, after the modification step, the water has a lower conductivity than the chosen water source. The modification step can include, for example, reverse osmosis purification, other mechanical filtration (e.g., ultrafiltration or nanofiltration), distillation, chemical treatments that remove certain ions (such as ion exchange), blending the chosen water source with a relatively purer water source (e.g., glacier water or desalinated water) so that the blended water is comparatively more pure, and combinations of the foregoing.

The terms “purifying” or “purified” as used herein in connection with the spray cooling water source can refer to any techniques such as the foregoing that are effective to reduce the total TDS, reduce the total ion value, and/or reduce the concentration of specific ions in the water. In one aspect, the purified water can be evaluated based on the conductivity, which is a measure of the amount of ions in the water. The conductivity of the purified source water after the modification step can be below 5,000 μS/cm, below 1,000 μS/cm, such as from 0.055 to 500 μS/cm, from 0.5 to 300 μS/cm, or from 1 to 100 μS/cm. The total TDS of the purified source water after the modification step can be less than 2,500 ppm, less than 1,000 ppm, less than 250 ppm, such as from 0.1 ppm to 100 ppm. The modification step can also be selected and controlled to reduce the number of target ions in the water. The target ions that are reduced in the modification stage can include ions selected from the group of chloride, sulfate, nitrate, nitrite, carbonate, fluoride, bromide, chlorate, chlorite, bromate, sodium, silicon, iron, bicarbonate, silicate, thiosulfate, anions of organic acids, and combinations thereof. After the modification step any one of these target ions or the total amount of these ions together can be less than 500 ppm, less than 250 ppm, or less than 100 ppm, e.g., from 0.1 ppm to 50 ppm.

After the step of modifying the spray cooling water to provide a more purified water, at least one additive can be combined with the more purified water. In particular, an antioxidant additive can be selected and dosed with the more purified water to form a protective barrier coating on the electrode surface when the water is sprayed onto the electrode, which reduces the electrode sidewall losses. Suitable antioxidant additives and techniques for combining the antioxidant additive with a spray cooling water source are described in Applicant's U.S. Pat. No. 10,694,592, which is incorporated by reference herein in its entirety. The additive can be chosen and dosed so that the manufactured spray cooling water has a desired water chemistry, e.g., with respect to certain minerals and/or ions. Thus, in some embodiments, the additive can increase the number of ions relative to the purified water that exits the modification step. Thus, the manufactured spray cooling water that includes an additive can have a conductivity of from 25 to 10,000 μS/cm, from 500 to 6,000 μS/cm, or from 1,000 to 5,000 μS/cm. The additive can be combined with the more purified water in any suitable amounts, such as in amounts sufficient so that the manufactured spray water has a TDS of from 10 ppm to 6,000 ppm, 25 ppm to 2,500 ppm, from 50 ppm to 1,000 ppm, or from 100 ppm to 800 ppm. The additive can be selected so that the manufactured spray cooling water nonetheless has a concentration of certain ions, including chloride, sulfate, nitrate, nitrite, carbonate, fluoride, bromide, chlorate, chlorite, bromate, sodium, silicon, iron, bicarbonate, silicate, thiosulfate, anions of organic acids, and/or combinations thereof, that is less than750 ppm, less than 500 ppm or less than 300 ppm, for example. Also, even with the additive(s), the manufactured spray water can comprise at least 95 wt. % water, at least 99 wt. % water, or at least 99.5 wt. % water.

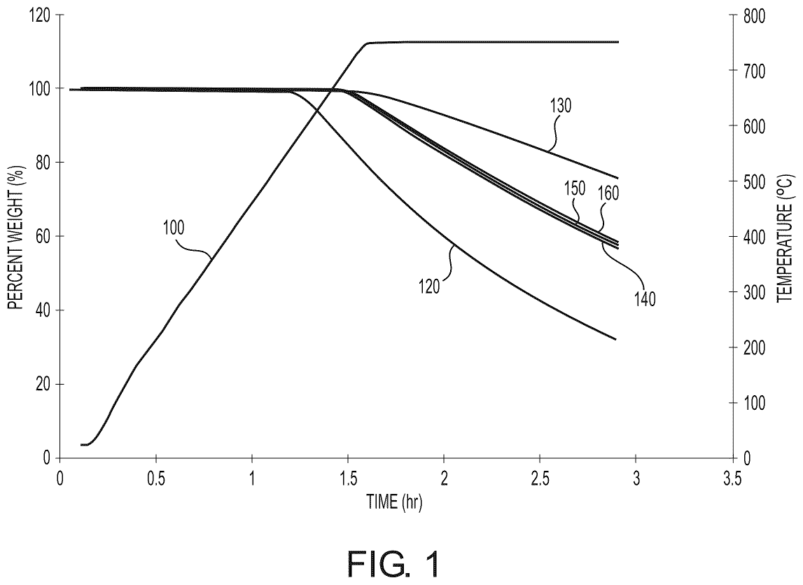

FIG. 1 is a graph that illustrates laboratory experimental results showing the inventors' discovery that the site water chemistry of the spray cooling water can significantly affect the rate of sidewall oxidation. In this experiment, the sidewall oxidation rates of test graphite electrodes were evaluated as a percentage of the weight lost by each electrode over time. An electrode that maintains 100% of its weight over time is ideal and would have no measurable sidewall oxidation losses. In FIG. 1, line 100 shows the temperature of the test electrode over time where the electrode reaches a steady state temperature of about 750° C. after 1.5 hours. Line 120 shows the oxidative losses of a graphite electrode that is constantly cooled with spray cooling water that has been prepared in a laboratory to mimic typical site water that has high TDS. The conductivity of the high TDS water used in this experiment is 1879 μS/cm. Line 130 shows the oxidative losses of a graphite electrode that is constantly cooled with spray water that is manufactured by modifying water from a municipal source in a purification process. Line 140 shows the oxidative losses of a graphite electrode that is constantly cooled with spray water that is manufactured by adding 250 ppm TDS equivalent to the purified municipal water, line 150 shows the oxidative losses of an electrode that is cooled with spray water that is manufactured by adding 500 ppm TDS equivalent to the purified municipal water, and line 160 shows the oxidative losses of an electrode that is cooled with spray water that is manufactured by adding 1000 ppm TDS equivalent to the purified municipal water.

As shown in FIG. 1, it was discovered that the graphite electrodes experienced substantially greater oxidation losses when cooled with high TDS water, which has high conductivity, as compared to purified municipal water. For example, after 2.75 hours of use, the graphite electrode cooled with purified municipal water maintained about 78% of its original weight, whereas the graphite electrode cooled with the high TDS water maintained only about 50% of its original weight. This comparison shows that something in the high TDS water is accelerating graphite oxidation. FIG. 1 also illustrates that spray cooling water that is made from purified water in which TDS is added in varying amounts can exhibit more sidewall oxidation losses than the purified water itself. Although these experiments were run in a laboratory on test graphite electrodes, it would be expected that percentage weight loss results for an electrode in an operating furnace would be similar, at least with respect to the heated area of the electrode.

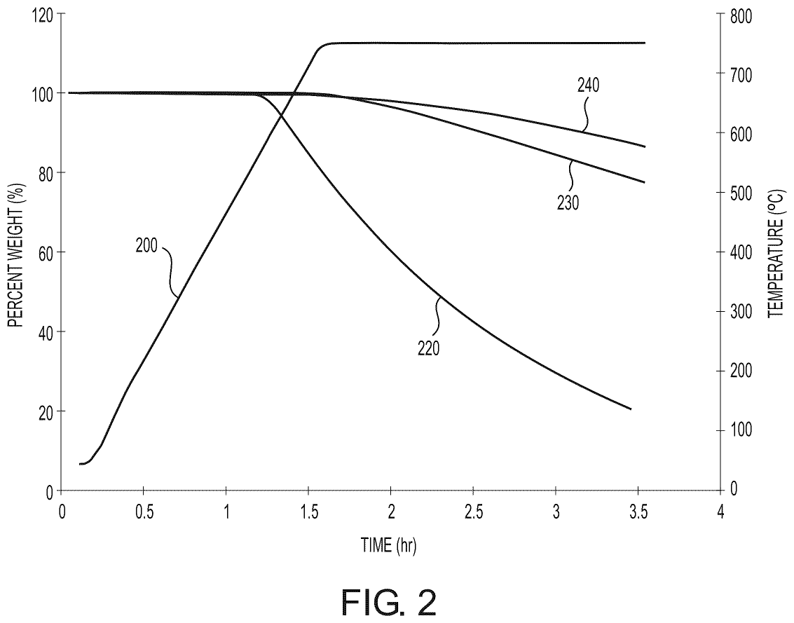

FIG. 2 is a graph that illustrates experimental results from another test that compares the oxidative losses of test graphite electrode cooled with high TDS water and with various manufactured spray waters. Line 200 shows the temperature of the test electrode over time. Line 220 shows the oxidative losses of a graphite electrode that is constantly cooled with the high TDS water, which has a conductivity of 1879 μS/cm. Line 230 shows the oxidative losses of a graphite electrode that is constantly cooled with spray water that is manufactured by modifying municipal water to be more pure in a purification process. Line 240 shows the oxidative losses of a graphite electrode that is cooled with spray water that is made by adding an antioxidant additive to the high TDS water in the manner described in connection with Applicant's U.S. Pat. No. 10,694,592 to form a protective barrier coating on the electrode surface when the water is sprayed onto the electrode. FIG. 2 illustrates that the oxidative losses of a graphite electrode can be substantially improved by modifying the cooling water source to be more pure or by modifying the high TDS water to include an antioxidant additive.

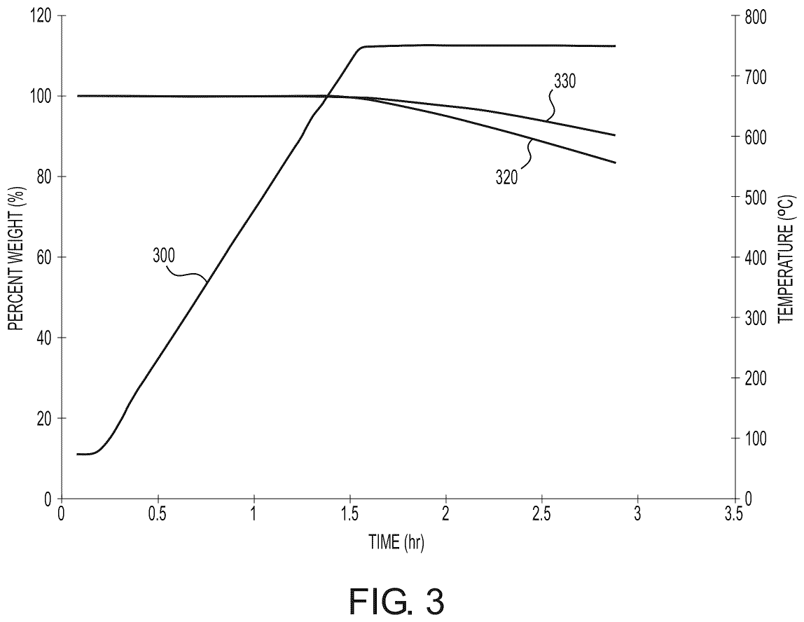

FIG. 3 is a graph that illustrates experimental results from a test that compares the oxidative losses of a test graphite electrode cooled with different manufactured spray cooling waters. Line 300 shows the temperature of the test electrode over time. Line 320 shows the oxidative losses of a graphite electrode that is constantly cooled with spray water that is manufactured by modifying municipal water to be more pure in a purification process. Line 330 shows the oxidative losses of a test graphite electrode that is constantly cooled and treated with spray water that is manufactured by (i) first modifying municipal water to be more pure; and (ii) then combining an antioxidant additive with the purified spray cooling water that will form a protective barrier coating on the electrode surface (the latter step is based on the techniques described in U.S. Pat. No. 10,694,592). FIG. 3 shows that improvements in electrode sidewall oxidation can be achieved by purifying the chosen spray cooling water, and that even further improvements can be achieved by adding an antioxidant additive to the purified spray cooling water. FIGS. 2 and 3 also shows that manufacturing the spray cooling water by purifying a water source and then adding an antioxidant additive can show improvements in sidewall oxidation as compared with using spray cooling water that is made by adding the antioxidant additive directly to high TDS water.

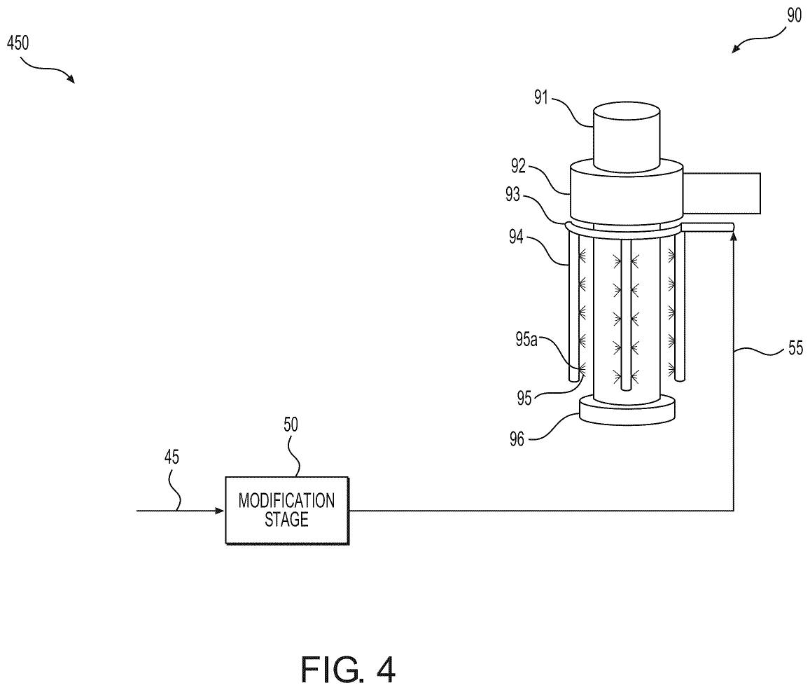

FIG. 4 illustrates a spray cooling water system 440 according to one embodiment in which the water chemistry of the spray cooling water can be engineered to improve sidewall oxidation performance. The cooling water system 440 includes water source 45 that is fed to a modification stage 50. The water source 45 can include any water source that is available on the site, such as, for example, municipal water, river water, lake water, blow down water, and other industrial water used in industrial processes.

The water source 45 is fed to modification stage 50 where the water is modified/purified to produce purified water 55. The modification stage can include any of the processes described above that either reduces the total amount of TDS, reduces the total amount of ions dissolved in the water and/or selectively reduces certain ions in the water.

In the FIG. 4 embodiment, the purified site water 55 is the manufactured spray water that is fed to the spray water cooling arrangement 90 to cool the electrode, or can optionally first be sent to a spray water storage tank (not pictured). In this embodiment, the spray water cooling arrangement 90 is illustrated in connection with a direct current furnace, but similar arrangements can be provided for multiple electrodes used in alternating current furnaces. As shown in FIG. 4, an electrode holder or clamp 92 holds the graphite electrode 91 which extends into the furnace through the top of the furnace 96 (furnace dome). The spray cooling arrangement 90 has a circular ring distribution header 93 and a vertical spray distribution header 94. The vertical spray distribution header 94 includes a plurality of nozzles 95a from which the manufactured spray water 95 is sprayed onto the outer circumference of the electrode 91. In this manner, the cooling of the electrode occurs from the electrode holder 92 to the top of the furnace 96.

The manufactured spray water 55 can be sprayed onto furnace electrode 91 while the furnace is electrified and in use melting raw materials such as steel. Additionally, or alternatively, the manufactured spray water 55 can be sprayed onto the hot furnace electrode during the dwell time of the furnace, during which time the electrode is not electrified, is placed into a holder, and is considered to be in an idle period. During the dwell period, the electrode is removed from the clamp that provides electricity to the electrode, and is placed in the holder. The holder is an offline station where electrode additions and/or further inspections of the electrode can occur. For example, in a typical dwell period, the clamp 92 is loosened and the electrode is withdrawn from the furnace by a crane, which then places the hot electrode in a holder (which is typically a steel deck with a hole that is sized to receive the electrode). The crane can then release the electrode while the electrode is held in the holder and pick up new electrode segments to add to the electrode. The crane can then return the electrode to the furnace and the clamp 92 can reengage the electrode. During this dwell time, the electrode is still very hot and will experience significant oxidation losses. According to some embodiments, the manufactured cooling spray water 55 can be applied (e.g., sprayed) onto the electrode surface during the dwell time. This enables the manufactured spray water to be applied to the entire electrode surface if desired, including portions of the electrode surface that were above the furnace dome and portions of the electrode that were below the furnace dome. One way of applying the manufactured spray water during the dwell time would be to provide a spray header that is mounted on the holder (e.g., around the hole) so that it can spray the electrode surface as the crane inserts the electrode into the holder. In embodiments, the manufactured spray water can be sprayed over at least 50% of the surface area of the hot electrode surface that was below the furnace dome, or over at least 75% or 90% of the surface area. As used herein a “hot” surface of the electrode refers to a surface temperature of at least 600° C. The temperature of the electrode surface during use while melting raw materials may be at least 700° C., at least 1000° C., at least 1200° C., at least 1800° C., or at least 3000° C., and the temperature of the electrode surface during the dwell time may be at least 700° C. or at least 800° C., for example. These temperatures are sufficiently hot to quickly evaporate the water in the manufactured spray cooling water as it is applied to the electrode surface.

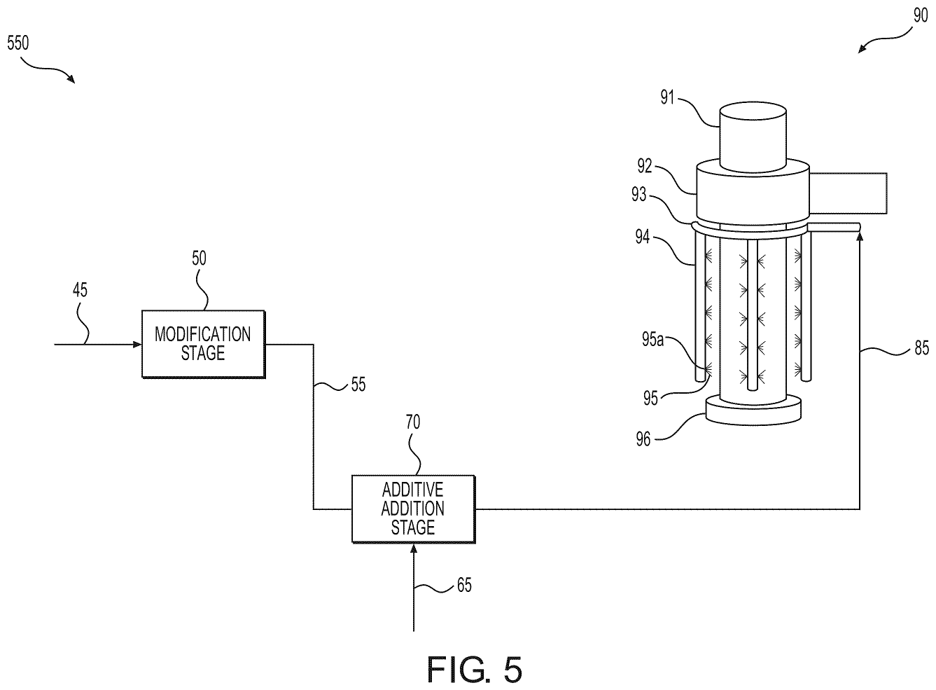

FIG. 5 illustrates a spray cooling water system 550 according to another embodiment in which the water chemistry of the spray water is further manufactured to include an antioxidant additive. The cooling water system 550 is otherwise the same as the FIG. 4 embodiment except that the purified source water 55 is combined with the antioxidant additive 65 in an additive addition stage 70 to provide manufactured spray water 85.

The antioxidant additive 65 can include at least one antioxidant additive that is in powder or liquid form. The antioxidant additive stage 70 can include a mixing stage or mixing container where the purified water 55 is mixed or stirred to combine the antioxidant additive 65. The antioxidant additive stage 70 can likewise simply comprise a junction where the antioxidant additive 65 and purified water 55 are combined, and allowed to mix as the manufactured spray water 85 is pumped to the spray cooling water stage 90. The antioxidant additive 65 can include any suitable additive that will form a protective coating on the furnace electrode. Suitable antioxidant additives, suitable amounts, suitable methods of metering the antioxidant additive, and suitable methods of forming the protective coating from the antioxidant additive are described in in U.S. Pat. No. 10,694,592, which has been incorporated by reference herein.

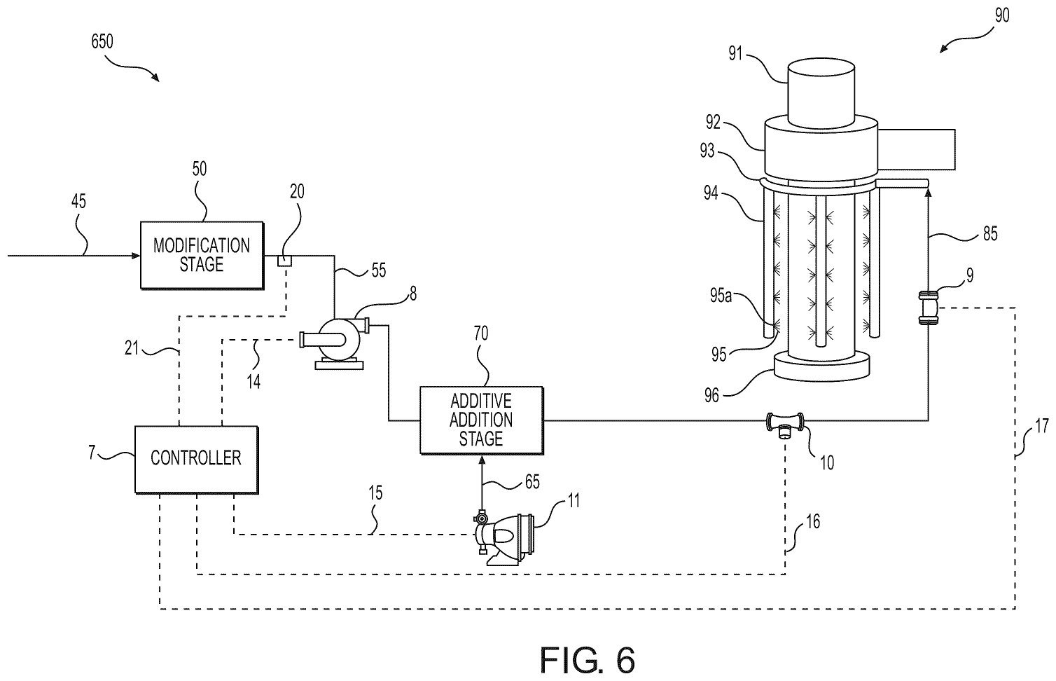

The antioxidant additive can be selected and provided in amounts to provide a desired chemical make-up (e.g., in terms of ion concentration) of the manufactured spray water 85, and can also be selected or added in amounts that are based on the chemical make-up of purified water 55 and/or based on the chemical make-up of the source water 45 as described below in more detail in connection with FIG. 6.

The manufactured spray water 85 is then fed to the spray water cooling arrangement 90, which is the same in this embodiment as in FIG. 4. The manufactured spray water 85 can be sprayed onto furnace electrode 91 while the furnace is electrified and in use melting raw materials. Additionally, or alternatively, the manufactured spray water 85 can be applied onto the hot furnace electrode during the dwell time of the furnace, during which the manufactured spray water can optionally be sprayed over all portions of the electrode surface if desired, including the portions that were below the furnace dome in the same manner as described above. Whether applied when in use melting raw materials or during the dwell time, spraying the manufactured spray water 85 onto the hot furnace electrode surface will cause water to evaporate from the spray water and the antioxidant additive will precipitate or deposit onto the electrode surface and form a protective barrier coating on the electrode surface that can reduce sidewall oxidation. It has surprisingly been discovered in connection with this disclosure that, in many cases, the protective barrier coating is more effective in preventing sidewall oxidation when the spray cooling water is manufactured by combining the antioxidant additive with purified source water.

FIG. 6 illustrates a spray cooling water system 650 according to another embodiment. In the FIG. 6 embodiment, the manufactured spray water 85 for the furnace electrode 91 is made with the same stages as the FIG. 5 embodiment, i.e., with a modification stage 50 and an additive addition stage 70. FIG. 6 illustrates an exemplary automated control scheme, and alternatives thereof, in which a controller 7 can be programmed to provide manufactured spray water 85 with a desired chemical composition or desired properties. The controller 7 can include one or more processors (e.g., CPUs) that are programmed with algorithms to perform the functions described herein, and the controller 7 may communicate with one or more memories that store preset information, such as threshold values of properties of concentrations of components.

The cooling spray water system 650 can include one or more sensors 20 that measure a property or composition of the purified water 55 and send signals 21 to controller 7, in which signals 21 convey the measured information. Various sensors or probes 20 can be positioned to measure properties or components of the purified water 55, including, for example, conductivity, resistivity, total dissolved solids, and/or concentration of specific ions. Where the modification stage 50 includes blending of two or more water sources, the cooling spray water system 650 can include flow meters and valves for each stream that can be controlled by controller 7 so that the composition of the purified water 55 can be controlled. The cooling spray water system 650 can also include an in-line flow meter 10 to measure the flow rate of manufactured spray water 85 and send signals 16 to the controller 7. The controller 7 can be programmed to calculate a dosage of the antioxidant 65 based on at least the information from the sensor 20, and optionally based on the information from the flow sensor 10 or based on a preset flow rate. The controller 7 can be programmed to send control signs 14 to actuate a pump 8 (e.g., a booster pump) to supply purified water 55 at a desired rate, and can be programmed to send control signals 15 to actuate a chemical metering skid 11 to supply the antioxidant additive 65 at a desired rate. In this way, using information from at least sensor 20, the controller 7 can automatically provide a manufactured spray water 85 that has a desired chemical composition or desired properties. For example, the chemistry of the manufactured spray water 85 can be controlled so that it has specific ions in predetermined concentrations (i.e., less than or more than predefined threshold amounts) or to have a predefined scaling index value, for example (e.g., LSI). A control valve 9 can regulate the flow for spray cooling to each individual electrode, based on signal 17 from the controller.

As indicated above, the composition of water source 45 can be highly variable, which can affect the composition of the purified water 55. The use of sensors 20 to measure composition information or property information of the purified water 55 allows the manufactured spray water 85 to be engineered to the desired or preset specifications. Accordingly, in one aspect, the controller 7 can determine the amount or type of antioxidant additive 65 to add in real time based on the measured property or measured composition information of the purified water 55. For example, the amount or type of antioxidant additive 65 that is added to make the manufactured spray water 85 may depend on the measured conductivity or the measured level of certain ions. In addition to or as an alternative to using sensors 20 to measure the composition or properties of the purified water 55, it is also possible to include sensors to measure similar parameters of the water source 45 and send signals with that information to controller 7. In such a case, the controller 7 can be programmed to calculate the amount or type of antioxidant additive 65 in part based on the composition or property information from the water source 45. The specifications for the desired spray water chemistry and the control scheme used to achieve the specifications can be different for each facility or for each furnace, since different spray water chemistries may be needed on different types of furnace operations and each facility has different source water.

The embodiments of the invention described herein can enable significant reductions in the sidewall oxidation of the furnace electrode, which reduces the cost of the electrodes (i.e., reduces the rate at which they are consumed during use), reduces carbon emissions associated with sidewall oxidation, and can improve the life of the furnace equipment.

It will be apparent to those skilled in the art that variations of the process and systems described herein are possible and are intended to be encompassed within the scope of the present invention.

What is claimed is:

1. A method for protecting a furnace electrode from sidewall oxidation, the method comprising:
(i) providing a water source for use in cooling the furnace electrode;
(ii) modifying the water source to provide a more purified water that has a lower total dissolved solids (TDS) than the water source; and
(iii) spraying a hot surface of the furnace electrode with manufactured spray cooling water, which includes the more purified water, to cool the furnace electrode.

2. The method according to claim 1, further comprising a step of forming the manufactured spray cooling water by combining the more purified water with at least one additive.

3. The method according to claim 2, wherein the at least one additive increases the TDS of the manufactured spray cooling water as compared to the more purified water.

4. The method according to claim 2, further comprising forming a coating on the furnace electrode that comprises the at least one additive, which is applied to the surface of the furnace electrode as water evaporates from manufactured spray cooling water that has been sprayed onto the surface of the furnace electrode.

5. The method of claim 1, wherein the step of modifying the water source includes purifying the water source with at least one of reverse osmosis, ultrafiltration, nanofiltration, distillation, and blending the water source with another water source that has a relatively lower TDS.

6. The method of claim 1, wherein the step of modifying the water source includes a chemical treatment that causes the more purified water to have a lower concentration of at least one ion as compared to the water source.

7. The method of claim 1, wherein the more purified water has a conductivity of less than 5,000 μS/cm.

8. The method of claim 1, wherein the more purified water has a conductivity of from 0.1 to 500 μS/cm.

9. The method of claim 1, wherein the more purified water has a TDS of less than 250 ppm.

10. The method of claim 2, wherein the manufactured spray water has a higher concentration of ions than the purified water.

11. The method of claim 1, wherein the manufactured spray water has a conductivity of from 25 to 10,000 μS/cm.

12. The method of claim 2, wherein the manufactured spray water has a TDS that is from 10 ppm to 6,000 ppm.
